(19) United States
(12) Patent Application Publication
(10) Pub. No.: US 2024/0201304 A1
(43) Pub. Date: Jun. 20, 2024

(54) VEHICLE AND DEPLOYABLE LOCATION MARKING SYSTEM

(71) Applicant: Ramon Ledgister, II, Carlsbad, CA (US)

(72) Inventor: Ramon Ledgister, II, Carlsbad, CA (US)

(21) Appl. No.: 18/084,678

(22) Filed: Dec. 20, 2022

(51) Int. Cl. G01S 1/04; B60L 1/00; B60Q 7/00

(52) U.S. Cl. CPC G01S 1/0423; B60L 1/00; B60Q 7/00

(57) ABSTRACT

A vehicle and deployable location marking system for deploying from a vehicle includes a vehicle including an exterior frame and an undercarriage. A power source is mounted on the vehicle and an electromagnet is coupled to the undercarriage of the vehicle and is electrically coupled to the power source. A switch is electrically coupled to the electromagnet and is mounted on the steering wheel, wherein the switch turns on or off a magnetized condition the electromagnet. A beacon for marking a location is releasably coupled to the electromagnet and releases from the electromagnet when actuated by the switch to a demagnetized condition.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to location markers and more particularly pertains to a new location marker for deploying from a vehicle.

### Description of Related Art Including Information Disclosed Under 37 CFR 1.97 and 1.98

The prior art relates to location markers and includes a variety of location markers being deployable from a vehicle. Known prior art does not include a location marker being releasably coupled to an electromagnet coupled to an undercarriage of the vehicle.

### BRIEF SUMMARY OF THE INVENTION

An embodiment of the disclosure meets the needs presented above by generally comprising a vehicle including an exterior frame and an undercarriage. A power source is mounted on the vehicle and an electromagnet is coupled to the undercarriage of the vehicle and is electrically coupled to the power source. A switch is electrically coupled to the electromagnet and is mounted on the steering wheel, wherein the switch turns on or off a magnetized condition the electromagnet. A beacon for marking a location is releasably coupled to the electromagnet and releases from the electromagnet when actuated by the switch to a demagnetized condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a vehicle and deployable location marking system according to an embodiment of the disclosure.

FIG. 2 is a perspective view of an embodiment of the disclosure.

FIG. 3 is a top view of an embodiment of the disclosure.

FIG. 4 is a front view of an embodiment of the disclosure.

FIG. 5 is a cross-sectional view of an embodiment of the disclosure taken along Line 5-5 of FIG. 3.

FIG. 6 is an exploded view of an embodiment of the disclosure.

FIG. 7 is an in-use view of an embodiment of the disclosure.

FIG. 8 is an in-use view of an embodiment of the disclosure.

FIG. 9 is a block diagram view of an embodiment of the disclosure.

### DETAILED DESCRIPTION OF THE INVENTION

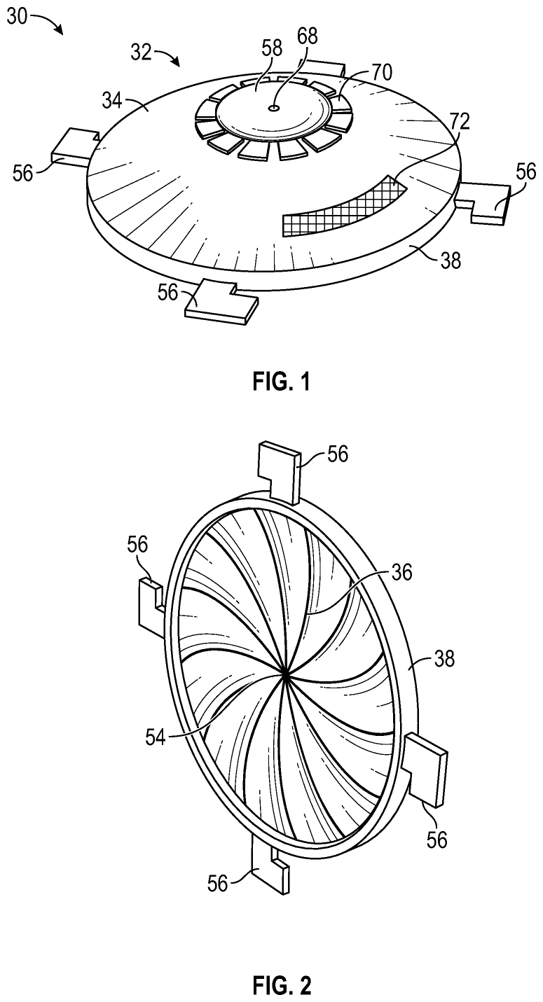

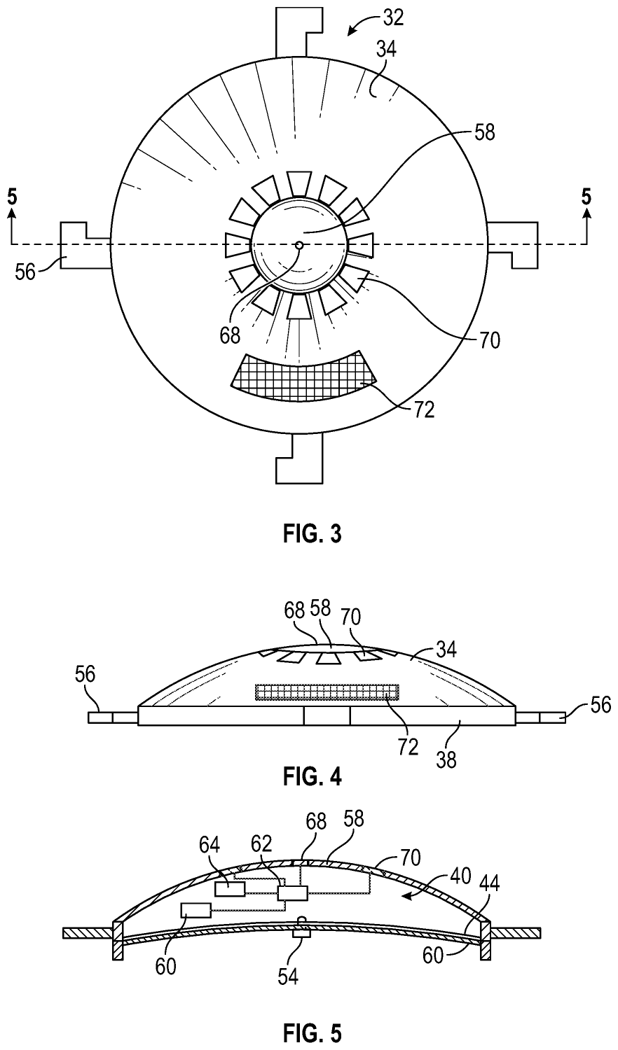

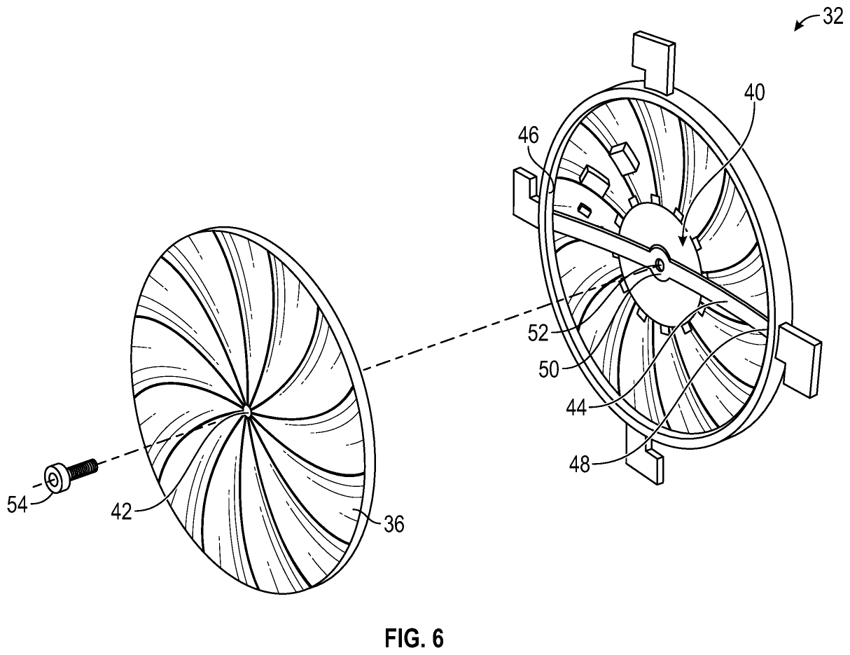

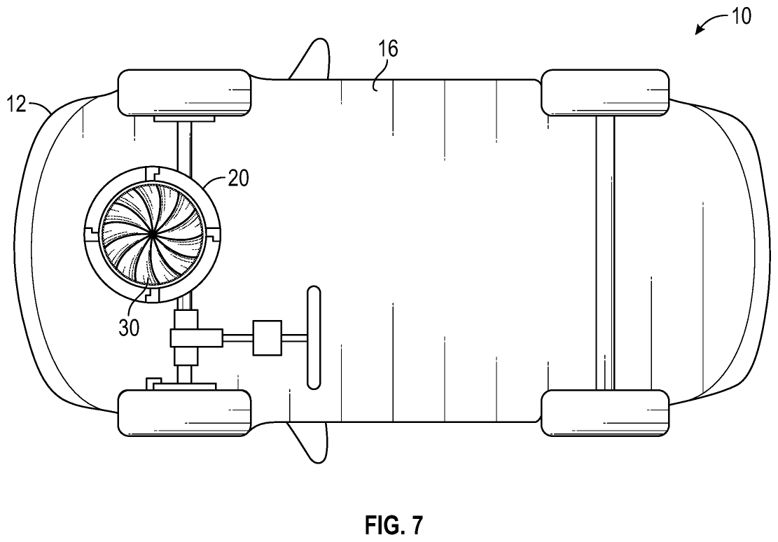

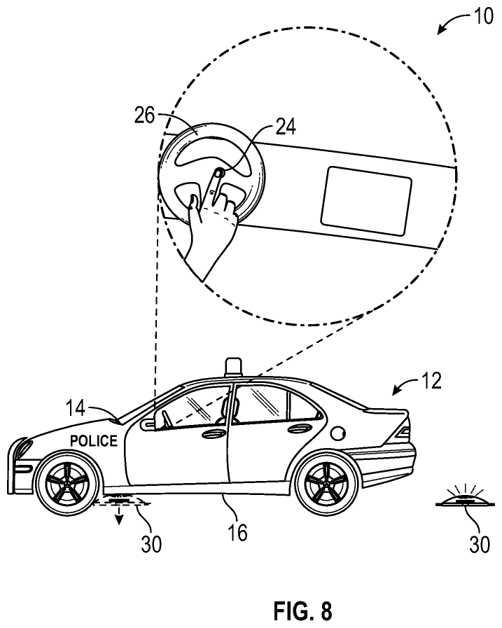

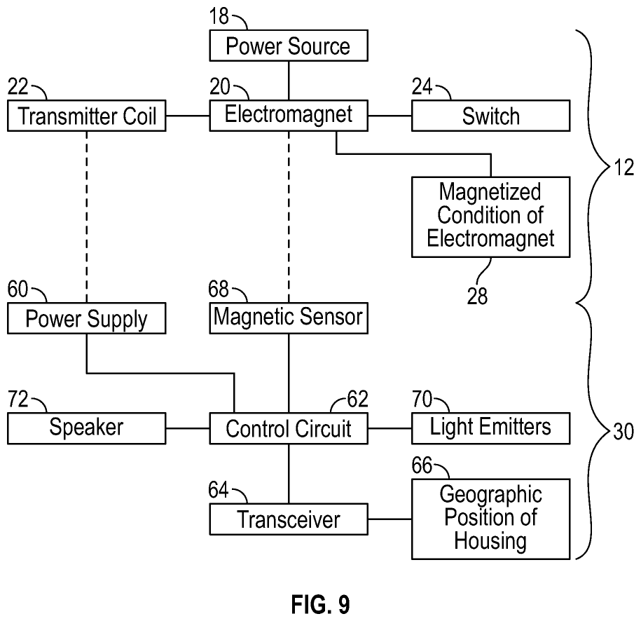

With reference now to the drawings, and in particular to FIGS. 1 through 9 thereof, a new location marker embodying the principles and concepts of an embodiment of the disclosure and generally designated by the reference numeral 10 will be described.

As best illustrated in FIGS. 1 through 9, the vehicle and deployable location marking system 10 generally comprises a vehicle 12 including an exterior frame 14 and an undercarriage 16. A power source 18 is mounted on the vehicle 12 and normally comprises a battery. An electromagnet 20 is coupled to the undercarriage 16 of the vehicle 12 and is electrically coupled to the power source 18. The electromagnet 20 may have a transmitter coil 22. A switch 24 is electrically coupled to the electromagnet 20 and is mounted on a steering wheel 26, wherein the switch 24 turns on or off a magnetized condition 28 the electromagnet 20.

A beacon 30 for marking a location is releasably coupled to the electromagnet 20 and releases from the electromagnet 20 when actuated by the switch 24 to a demagnetized condition. The beacon 30 includes a housing 32 including a top wall 34, a bottom wall 36, and a perimeter wall 38 attached to and extending between the top 34 and bottom 36 walls. The housing 32 encloses an interior space 40. The bottom wall 36 may be removable from the housing 32 and have an aperture 42 extending therethrough. The perimeter wall 38 may have a bar 44 extending from a first side 46 of the perimeter wall 38 to a second side 48 of the perimeter wall 38 and a center 50 of the bar 44 may have a hole 52 extending therethrough. The aperture 42 of the bottom wall 36 may be removably positioned abutting the hole 52 of the bar 44 and a screw 54 may be threadably inserted through the aperture 42 and the hole 52 to retain the bottom wall 36 to the bar 44 of the perimeter wall 38.

A plurality of stabilizers 56 is coupled to the perimeter wall 38 and is configured to horizontally stabilize the housing 32 when the beacon 30 is release from the electromagnet 20. Each stabilizer 56 typically comprises a horizontally orientated L-shaped panel. A magnetically active plate 58 is coupled to the top wall 34 of the housing 32 and is releasably engaged with the electromagnet 20. The magnetically active plate 58 may comprise a metal or another material being magnetically active.

A power supply 60 is positioned within the interior space 40 of the housing 32 and typically comprises a rechargeable battery. The power supply 60 may receive electric power through wireless transmission from the transmitter coil 22 within the electromagnet 20. A control circuit 62 is electrically coupled to the power supply 60 and is positioned within the interior space 40 of the housing 32. A transceiver 64 is electrically coupled to the control circuit 62 and is configured for wirelessly transmitting a geographic position 66 of the housing 32 to facilitate locating the beacon 30 after it has been released from the vehicle 12.

A magnetic sensor 68 is coupled to the housing 32 and actuates the beacon 30 when released from the electromagnet 20. The magnetic sensor 68 is electrically coupled to the control circuit 62 and activates transceiver 64 of the beacon 30 when the magnetized condition 28 of the electromagnet 20 is turned off. A plurality of light emitters 70 is electrically coupled to the control circuit 62 and emits light when actuated by the magnetic sensor 68. The light emitters 70 are coupled to the top wall 34 of the housing 32 and may be positioned adjacent to the magnetically active plate 58. Each light emitter 70 of the plurality of light emitters 70 normally comprises a light emitting diode. A speaker 72 is electrically coupled to the control circuit 62 and emits an audible alarm 74 when actuated by the magnetic sensor 68. The speaker 72 will typically be positioned on the top wall 34 of the housing 32.

In use, the magnetized condition 28 of the electromagnet 20 is turned on to retain the magnetically active plate 58 of the beacon 30 to the vehicle 12. When the vehicle 12 is driving and needs to drop a location marker, the switch 24 is actuated to turn off the magnetized condition 28 of the electromagnet 20 to release the beacon 30 from the vehicle 12. The magnetic sensor 68 activates the transceiver 64, the light emitters 70, and the speaker 72 of the beacon 30 to facilitate locating the beacon 30 after it has been dropped from the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle and deployable location marking system comprising:
a vehicle including an exterior frame and an undercarriage;
a power source being mounted on the vehicle;
an electromagnet being coupled to said undercarriage of said vehicle and being electrically coupled to said power source;
a switch being electrically coupled to said electromagnet and being mounted on a steering wheel, wherein said switch turns on or off a magnetized condition said electromagnet; and
a beacon for marking a location being releasably coupled to said electromagnet and releasing from said electromagnet when actuated by said switch to a demagnetized condition.

2. The vehicle and deployable location marking system of claim 1, wherein said power source comprises a battery.

3. The vehicle and deployable location marking system of claim 1, wherein said electromagnet has a transmitter coil.

4. The vehicle and deployable location marking system of claim 1, wherein said beacon includes a housing including a top wall, a bottom wall, and a perimeter wall being attached to and extending between said top and bottom walls, said housing enclosing an interior space.

5. The vehicle and deployable location marking system of claim 4, further including a plurality of stabilizers being coupled to said perimeter wall and being configured to horizontally stabilize said housing, each stabilizer comprising a horizontally orientated L-shaped panel.

6. The vehicle and deployable location marking system of claim 5, further including a magnetically active plate being coupled to said top wall of said housing and being releasably engaged with said electromagnet.

7. The vehicle and deployable location marking system of claim 6, further including a power supply being positioned within said interior space of said housing, said power supply comprising a rechargeable battery.

8. The vehicle and deployable location marking system of claim 7, further including a control circuit being electrically coupled to said power supply, said control circuit being positioned within said interior space of said housing.

9. The vehicle and deployable location marking system of claim 8, further including a transceiver being electrically coupled to said control circuit and being configured for wirelessly transmitting a geographic position of said housing.

10. The vehicle and deployable location marking system of claim 9, further including a magnetic sensor being coupled to said housing and actuating said beacon when released from said electromagnet, said magnetic sensor being electrically coupled to said control circuit.

11. The vehicle and deployable location marking system of claim 10, further including a plurality of light emitters being electrically coupled to said control circuit and emitting light when actuated, said light emitters being coupled to said top wall of said housing, said light emitters being positioned adjacent to said magnetically active plate, each light emitter of said plurality of light emitters comprising a light emitting diode.

12. The vehicle and deployable location marking system of claim 11, further including a speaker being electrically coupled to said control circuit and emitting an audible alarm when actuated, said speaker being positioned on said top wall of said housing.

13. A vehicle and deployable location marking system comprising:
a vehicle including an exterior frame and an undercarriage;
a power source being mounted on the vehicle, said power source comprising a battery;
an electromagnet being coupled to said undercarriage of said vehicle and being electrically coupled to said power source, said electromagnet having a transmitter coil;
a switch being electrically coupled to said electromagnet and being mounted on a steering wheel, wherein said switch turns on or off a magnetized condition said electromagnet;
a beacon for marking a location being releasably coupled to said electromagnet and releasing from said electromagnet when actuated by said switch to a demagnetized condition, said beacon including:
a housing including a top wall, a bottom wall, and a perimeter wall being attached to and extending between said top and bottom walls, said housing enclosing an interior space;
a plurality of stabilizers being coupled to said perimeter wall and being configured to horizontally stabilize said housing, each stabilizer comprising a horizontally orientated L-shaped panel;
a magnetically active plate being coupled to said top wall of said housing and being releasably engaged with said electromagnet;
a power supply being positioned within said interior space of said housing, said power supply comprising a rechargeable battery;
a control circuit being electrically coupled to said power supply, said control circuit being positioned within said interior space of said housing;
a transceiver being electrically coupled to said control circuit and being configured for wirelessly transmitting a geographic position of said housing;
a magnetic sensor being coupled to said housing and actuating said beacon when released from said electromagnet, said magnetic sensor being electrically coupled to said control circuit;
a plurality of light emitters being electrically coupled to said control circuit and emitting light when actuated, said light emitters being coupled to said top wall of said housing, said light emitters being positioned adjacent to said magnetically active plate, each light emitter of said plurality of light emitters comprising a light emitting diode; and
a speaker being electrically coupled to said control circuit and emitting an audible alarm when actuated, said speaker being positioned on said top wall of said housing.
